(19) United States
(12) Patent Application Publication
(10) Pub. No.: US 2010/0127894 A1
(43) Pub. Date: May 27, 2010

(54) MAGNETO SENSOR FOR AN AIRCRAFT IGNITION SYSTEM

(75) Inventors: Michael D. Dwyer, Seminole, FL (US); Felix E. Valazquez, Valrico, FL (US); John Thornberry, Largo, FL (US)

Correspondence Address: HONEYWELL/FOGG;Patent Services, 101 Columbia Road, P.O Box 2245, Morristown, NJ, 07962-2245, US

(73) Assignee: HONEYWELL INTERNATIONAL INC., Morristown, NJ (US)

(21) Appl. No.: 12/277,138

(22) Filed: Nov. 24, 2008

(51) Int. Cl. G08B 21/00

(52) U.S. Cl. 340/945

(57) ABSTRACT

Systems and methods for indicating status of a piston engine magneto (MAG). An example system includes a MAG sensing circuit that senses a signal from the MAG and an indication device that output an indication of the operational status of the MAG based on the sensed signal. The MAG sensing circuit samples a signal from a P-lead of the MAG. The indication device determines if the sampled signal is below a predefined threshold value. The indication device includes a field effect transistor (FET) that receives the sampled signal at its gate. The FET is placed in an on state if the sampled signal is above the predefined threshold value, and the FET is placed in an off state if the sampled signal is below the predefined threshold value. A light is activated when the FET is in the on state and deactivated when the FET is in the off state.

### BACKGROUND OF THE INVENTION

General aviation piston powered airplanes use magnetos (MAGS) to generate the “spark” for the ignition of the engine. MAGS are basically a permanent magnet that sweeps by a coil and at the correct time an electrical switch called the “points” opens causing a high voltage (HV) pulse to be sent to the spark plug at the correct time for igniting a fuel air mixture in the cylinder. Aircraft use a MAG switch to control the MAGS. The MAG switch turns the MAG off by shorting the “Points” thus stopping the HV pulse to the spark plugs. Thus the MAG switch is a little unusual in that an open switch is MAG=ON and a closed switch is MAG=OFF. Many piston powered airplanes use two MAGS for improved reliability. If an aircraft is flying with two MAGS operating at say 2500 RPM and one MAG fails, the engine RPM drops to 2450 RPM and gets noticeably rougher. Thus it is easy for the pilot to detect something is wrong.

Technically advanced airplanes replace one MAG with an electronic ignition. These aircraft use one MAG and one electronic ignition. The MAG doesn't require electrical power to operate (thus making the aircraft electrical system non-flight critical) and the electrical ignition offers better fuel economy through vacuum advance and higher spark energy so there is good reason to set up the aircraft ignition with both systems.

When running the engine at 2500 RPM the electronic ignition is firing at 32 degrees before top dead center (BTDC) and the MAG is firing at a fixed 25 degrees BTDC. If the MAG fails in flight, there is NO sensory or other indication to the pilot that the MAG has failed. There is not an RPM drop or any noticeable engine roughness.

### SUMMARY OF THE INVENTION

The present invention provides systems and methods for indicating status of a piston engine magneto (MAG). An example system includes a MAG sensing circuit that senses a signal from the MAG and an indication device that output an indication of the operational status of the MAG based on the sensed signal.

In one aspect of the invention, the MAG sensing circuit samples a signal from a P-lead of the MAG. The indication device determines if the sampled signal is below a predefined threshold value.

In another aspect of the invention, the indication device includes a field effect transistor (FET) that receives the sampled signal at its gate. The FET is placed in an “on” state if the sampled signal is above the predefined threshold value, and the FET is placed in an “off” state if the sampled signal is below the predefined threshold value.

In yet another aspect of the invention, the indication device includes a light that is activated when the FET is in the “on” state and is deactivated when the FET is in the “off” state.

### BRIEF DESCRIPTION OF THE DRAWINGS

Preferred and alternative embodiments of the present invention are described in detail below with reference to the following drawings:

FIG. 1 is a schematic diagram of an example Magneto Status Sensor System formed in accordance with an embodiment of the present invention;

FIG. 2 is a schematic diagram of an example circuit used in the system of FIG. 1; and

FIG. 3 illustrates instrument panel components formed in accordance with an embodiment of the present invention.

### DETAILED DESCRIPTION OF THE INVENTION

A magneto (MAG) is controlled by a P-Lead. The P-Lead is a wire that comes from points of the MAG and is grounded by a MAG switch. When the MAG switch is open, the MAG points are not shorted out and the MAG produces a high voltage (HV) pulse to spark plugs when the engine is rotated. The HV pulse is a several hundred volt pulse when the MAG is operating. The present invention includes a circuit that senses the creation of the HV pulse and sends an indication to the pilot through a panel light and/or other system.

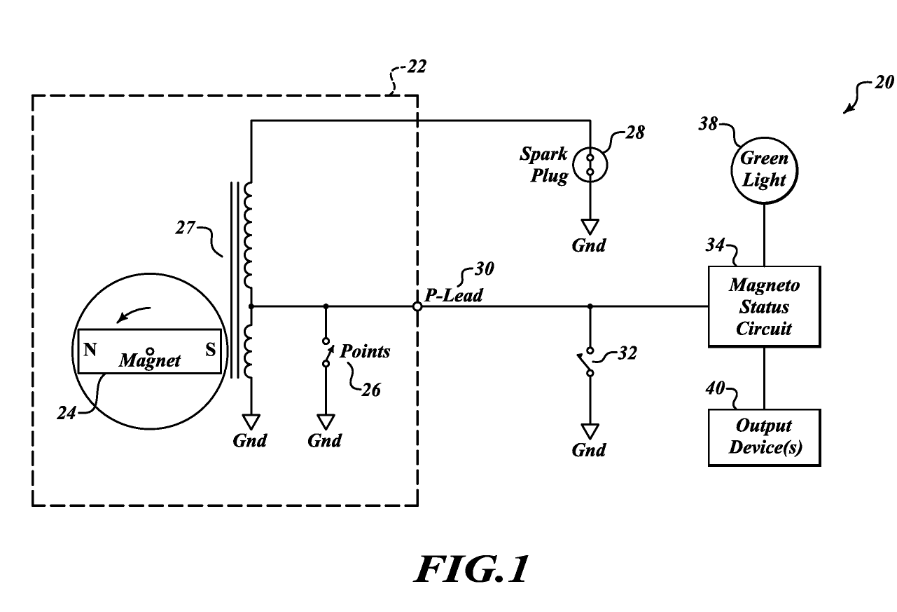

FIG. 1 illustrates a MAG circuit 20 that senses the status of a MAG. The MAG circuit 20 includes a MAG 22, a spark plug 28, a MAG switch 32, a MAG status circuit 34, an output light (green light) 38, and/or other output devices 40.

When a pilot throws a MAG toggle switch in the cockpit into an “on” position, the MAG switch 32 is placed in an open state thereby allowing the MAG 22 to output a high voltage pulse to the spark plug 28. The MAG 22 includes a rotating magnet 24, a charging coil 27 located adjacent to the magnet 24 and points 26. As the magnet 24 rotates past the charging coil 27 at just the right time, the points 26 open and an HV pulse (e.g., 10 kV) is sent by the charging coil 27 to the spark plug 28.

A P-lead 30 from the MAG 22 is connected to a first side of the MAG switch 32 and to the MAG status circuit 34. A second side of the MAG switch 32 is attached to ground. When the HV pulse is sent to the spark plug 28, the P-lead 30 outputs a much smaller voltage value (e.g., 200V). Once the MAG status circuit 34 senses the voltage at the P-lead 30, the light 38 is activated indicating that the MAG 22 is fully operational. In another embodiment, the MAG status circuit 34 sends a signal to one or more different types of output devices 40. The output devices may be used to store information associated with the signal received by the MAG status circuit 34 for later analysis of the MAG 22. Or an audio enunciator (not shown) is activated to enunce “MAG Failure Detected”, a comparable message or non-textual alerts (such as beeps).

In another embodiment, the other devices 40 includes a flight/engine monitor computer, which would be configured to display a MAG failure message or alert icon on a screen.

As shown in FIG. 2, the MAG status circuit 34 includes a field effect transistor (FET) 50 and other circuit components for applying a relatively smoothed out voltage value from the P-lead 30 when the MAG 22 is operating properly. When the FET 50 receives a steady voltage value (e.g. 4V reduced from about 200V by the resistor and zener diode) at its gate, the FET 50 is placed in an “ON” state thereby drawing current from a voltage source (e.g., +14 volts), thereby activating the light 38, such as a light emitting diode (LED).

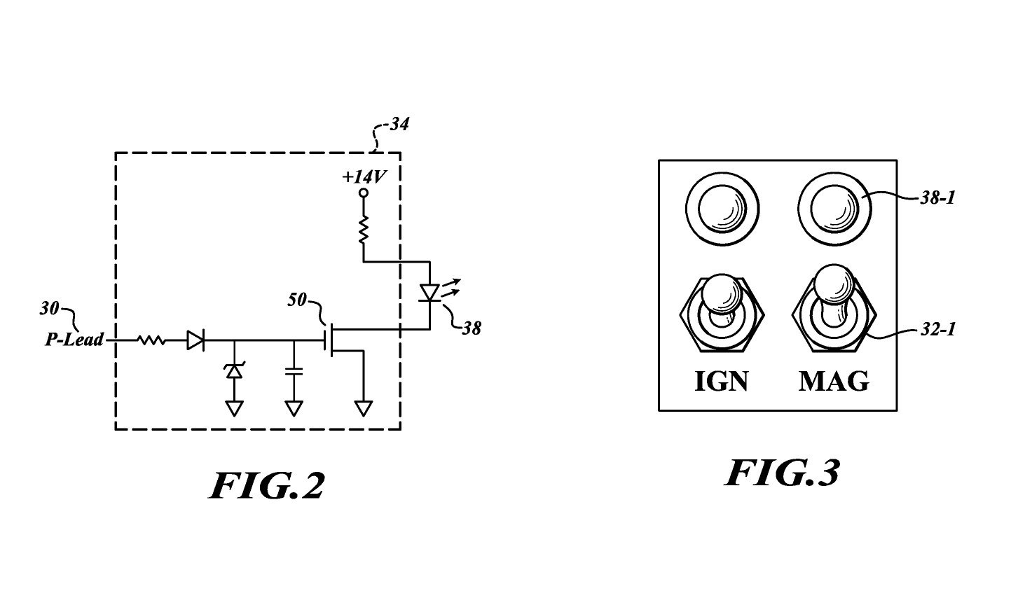

FIG. 3 illustrates lights and switches located on an instrument panel for an aircraft having the MAG circuit 20. A light 38-1 is preferably located proximate to a MAG switch 32-1. The MAG switch 32-1 is turned on prior to starting the aircraft. At that time, the light 38-1 is not illuminated. Once the engine starts and the MAG is functioning correctly, the light 38-1 above the switch 32-1 illuminates. During flight if the MAG fails, the green light 38-1 will extinguish.

When there is no voltage value or a voltage value below a threshold amount at the P-lead 30, the FET 50 receives a below threshold voltage value at its gate thereby operating in an “OFF” state. In the “OFF” state, the FET switch does not allow current to pass through the light 38-1 (i.e., not illuminate).

It is possible for the MAG to produce a nominal voltage and still be dysfunctioning. If this were to occur the components of the MAG status circuit 34 are selected to still place the FET 50 in the “OFF” state.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for indicating status of a piston engine magneto (MAG), the method comprising:
sensing a signal at a lead of a MAG circuit; and
indicating the MAG is operating properly, if the sensed signal is above a threshold value.

2. The method of claim 1, wherein sensing comprises sampling the signal from a P-lead of the MAG circuit, and wherein indicating comprises determining if the sampled signal is below a predefined threshold value.

3. The method of claim 2, wherein determining comprises applying the sampled signal to a gate of a field effect transistor (FET), placing the FET in an on state if the sampled signal is above the predefined threshold value, and placing the FET in an off state if the sampled signal is below the predefined threshold value.

4. The method of claim 3, wherein indicating further comprises applying a current to a light when the FET is in the on state and deactivating the current to the light when the FET is in the off state.

5. The method of claim 3, wherein indicating further comprises sending a MAG working signal to one or more devices when the FET is in the on state and sending a MAG not-working signal to the one or more devices when the FET is in the off state.

6. The method of claim 5, wherein the one or more devices comprise a processing device.

7. A system for indicating status of a piston engine magneto (MAG), the system comprising:
a MAG sensing circuit configured to sense a signal from the MAG; and
an indication device configured to output an indication of the operational status of the MAG based on the sensed signal.

8. The system of claim 7, wherein the MAG sensing circuit samples a signal from a P-lead of the MAG, and wherein the indication device determines if the sampled signal is below a predefined threshold value.

9. The system of claim 8, wherein the indication device comprises a field effect transistor (FET), the sampled signal is applied to a gate of the FET, whereby the FET is placed in an on state if the sampled signal is above the predefined threshold value, and the FET is placed in an off state if the sampled signal is below the predefined threshold value.

10. The system of claim 9, wherein the indication device further comprises a light that is activated when the FET is in the on state and is deactivated when the FET is in the off state.

11. The system of claim 9, wherein the indication device sends a MAG working signal to one or more devices when the FET is in the on state and sends a MAG not-working signal to the one or more devices when the FET is in the off state.

12. The system of claim 11, wherein the one or more devices comprise a processing device.

13. A system for indicating status of a piston engine magneto (MAG), the method comprising:
a means for sensing a signal at a lead of a MAG circuit; and
a means for indicating the MAG is operating properly, if the sensed signal is above a threshold value.

14. The method of claim 13, wherein the means for sensing samples the signal from a P-lead of the MAG circuit, and wherein the means for indicating determines if the sampled signal is below a predefined threshold value.

15. The method of claim 14, wherein the means for indicating applies the sampled signal to a gate of a field effect transistor (FET) that is placed in an on state if the sampled signal is above the predefined threshold value and placed in an off state if the sampled signal is below the predefined threshold value.

16. The method of claim 15, wherein the means for indicating applies a current to a light when the FET is in the on state and deactivates the current to the light when the FET is in the off state.

17. The method of claim 15, wherein the means for indicating sends a MAG working signal to one or more devices when the FET is in the on state and sends a MAG not-working signal to the one or more devices when the FET is in the off state.
